(19) United States
(12) Patent Application Publication
(10) Pub. No.: US 2008/0263172 A1
(43) Pub. Date: Oct. 23, 2008

(54) DISTRIBUTED SERVICES FOR MULTI-ENTITY COLLABORATION

(76) Inventors: Gary J. Hickerson, Columbus, OH (US); Joseph Pally, Katy, TX (US)

Correspondence Address: HAYNES AND BOONE, LLP, 901 Main Street, Suite 3100, Dallas, TX, 75202, US

(21) Appl. No.: 11/758,347

(22) Filed: Jun. 5, 2007

Related U.S. Application Data
(60) Provisional application No. 60/803,951, filed on Jun. 5, 2006.

(51) Int. Cl. G06F 15/16

(52) U.S. Cl. 709/217; 709/227

(57) ABSTRACT

Method for communication of service requests and service results between remotely located users and service providers. Connectivity is established between service providers and a request handler, and also between users and the request handler. Service requests are received at the request handler, a service provider ID is identified from each service request, and each service request is transmitted to a unique service provider associated with the service provider ID. The service requests received by the unique service provider are entered in a queue located central to the unique service provider, the queue existing in a spreadsheet computer program being executed by the unique service provider. An individual entry in the queue is removed for performing the requested service via the spreadsheet computer program, thereby generating a result. Result packages comprising the service results are then generated and transmitted to the corresponding, requesting users.

### CROSS-REFERENCE TO RELATED APPLICATIONS

The present application claims the benefit of the priority of the U.S. Provisional Patent Application No. 60/803,951, filed Jun. 5, 2006, entitled “DISTRIBUTED SERVICES FOR MULTI-ENTITY COLLABORATION,” the entirety of which is hereby incorporated by reference.

### BACKGROUND

Web Services (sometimes called application services) are services that are made available from a business's Web server for Web users or other Web-connected programs. Web Services usually include some combination of programming and data, but may also include human resources. Providers of Web services are generally known as service providers or application service providers. Current web services range from such major services as storage management and customer relationship management (CRM) down to much more limited services such as the furnishing of a stock quote and the checking of bids for an auction item. The accelerating creation and availability of these services is a major Web trend.

Users can access some Web services through a peer-to-peer arrangement rather than by going to a central server. Some services can communicate with other services and this exchange of procedures and data is generally enabled by a class of software known as middleware. Services previously possible only with the older standardized service known as Electronic Data Interchange (EDI) are increasingly likely to become Web services. Besides the standardization and wide availability to users and businesses of the Internet itself, Web services are also increasingly enabled by the use of the Extensible Markup Language (XML) as a means of standardizing data formats and exchanging data. XML is the foundation for the Web Services Description Language (WSDL).

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of apparatus according to one or more aspects of the present disclosure.

FIG. 2 is a schematic view of at least a portion of apparatus according to one or more aspects of the present disclosure.

FIG. 3 is a schematic view of at least a portion of apparatus according to one or more aspects of the present disclosure.

FIG. 4 is a schematic view of at least a portion of apparatus according to one or more aspects of the present disclosure.

FIG. 5 is a schematic view of at least a portion of apparatus according to one or more aspects of the present disclosure.

FIG. 6 is a schematic view of at least a portion of apparatus according to one or more aspects of the present disclosure.

FIG. 7 is a flow-chart diagram of at least a portion of a method according to one or more aspects of the present disclosure.

FIG. 8 is a schematic view of at least a portion of apparatus according to one or more aspects of the present disclosure.

FIG. 9 is a flow-chart diagram of at least a portion of a method according to one or more aspects of the present disclosure.

FIG. 10 is a schematic view of at least a portion of apparatus according to one or more aspects of the present disclosure.

FIG. 11 is a flow-chart diagram of at least a portion of a method according to one or more aspects of the present disclosure.

FIG. 12 is a schematic view of at least a portion of apparatus according to one or more aspects of the present disclosure.

FIG. 13 is a flow-chart diagram of at least a portion of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and may, but does not in itself, indicate a relationship between the various embodiments and/or configurations discussed.

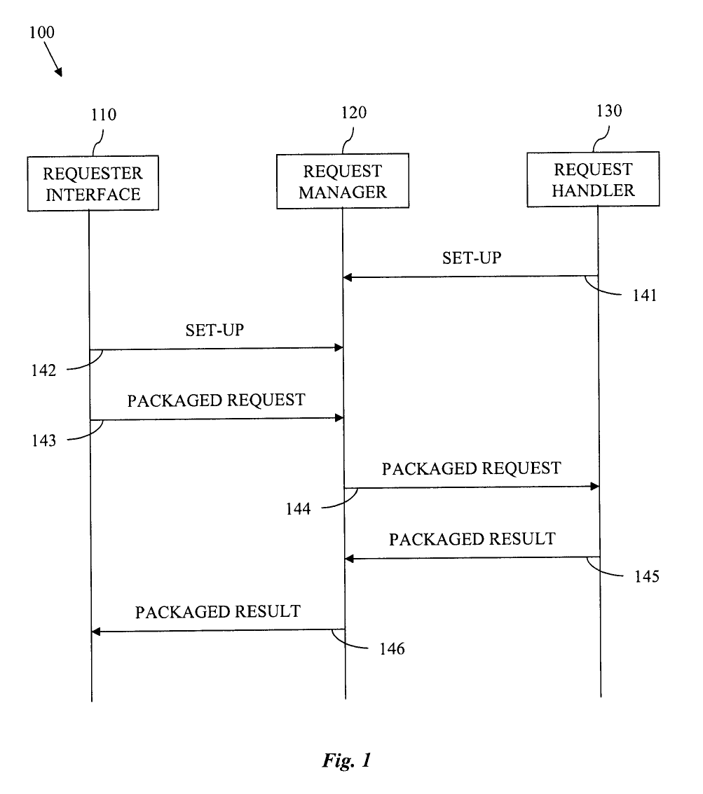

Referring to FIG. 1, illustrated is a schematic view of a system 100 according to one or more aspects of the present disclosure. The system 100 includes a requester interface 110, a request manager 120, and a request handler 130. Operation of the system 100 may include the following communications, whether in the sequence listed or otherwise:

| | Ref. | | |
|---|---|---|---|
| Communication | No. | Initiator | Target |
| Set-up | 141 | Request handler 130 | Request manager |
| | | | 120 |
| Set-up | 142 | Requester interface 110 | Request manager |
| | | | 120 |
| Packaged request | 143 | Requester interface 110 | Request manager |
| | | | 120 |
| Packaged request | 144 | Request manager 120 | Request handler |
| | | | 130 |
| Packaged result | 145 | Request handler 130 | Request manager |
| | | | 120 |
| Packaged result | 146 | Request manager 120 | Requester interface |
| | | | 110 |

Where a web service or similar service provider desires to offer its service to users of the system 100, the service provider may create a request handler 130 that is activated, connected to, or otherwise associated with the system 100. Upon its creation, the request handler 130 may be activated, connected to, authenticated, or otherwise associated with the system 100, which is accomplished via the set-up communication 141. For example, transmissions between the request handler 130 and the request manager 120 may convey to the request manager 120 various information about the identity of the request handler 130, such as a Service Provider ID (SPID) corresponding to the request handler 130, and possibly a Service ID (SID) where a service provider offers more than one service to users of the system 100. Transmissions between the request handler 130 and the request manager 120 during the set-up communication 141 may also include those directed towards verifying that the service provider is a current subscriber, and possibly verifying that the service provider's account includes no outstanding balances with regard to, for example, subscription fees.

The set-up communications 141 may also convey from the request handler 130 to the request manager 120 information pertaining to the data format and type which the request handler 130 requires in order to perform user-requested services. For example, the request handler 130 may expect to receive requests packaged as XML data having a predefined number of inputs. Of course, such is merely an example, and in no way limits the scope of the present disclosure. Additional details about the request handler 130 are also described later in this disclosure.

The set-up communications 142 between the requester interface 110 and the request manager 120 may be conceptually or otherwise similar to the set-up communication 141 in that, for example, both communications 141 and 142 may be directed towards establishing a connection or other association with the request manager 120. For example, in a manner that may be similar to the provision of the SPID and/or SID from the request handler 130 to the request manager 120, the set-up communication 142 may include the conveyance of a Requester ID (RID) and/or a Request Instance ID (RIID) between the requester interface 110 and the request manager 120. Transmissions between the requester interface 110 and the request manager 120 during the set-up communication 142 may also include those directed towards verifying that the requester (user) is a current subscriber, and possibly verifying that the requester's account includes no outstanding balances with regard to subscription or service fees.

The packaged request communications 143 may primarily include an individual service request, or several service requests, whether for a single or multiple service providers and/or services. For example, each service request included in a packaged request may include the RID corresponding to the user, at least one RIID, and the input parameters required by the requested service. Each service request may additionally include at least one SPID and/or SID corresponding to the requested service provider(s) and/or service(s). However, it is not necessary that the user know the SPID or SID of the requested service provider and/or service. That is, the SPID and/or SID, among other data, may be integrated into the requester interface 110, such that initiating a particular service request via the requester interface 110 may automatically incorporate the SPID, SID, and/or other information, in addition to the input parameters required for the requested service, such as billing information, authorization, or confirmation corresponding to the user and/or the service provider. Additional details about the requester interface 110 are also described later in this disclosure.

The second packaged request communications 144 may generally include data copied from one or more first packaged request communications 143. For example, a user may initiate a first packaged request communication 143 containing a service request for “service A” from “service provider X,” “service B” from “service provider Y,” and “service C” from “service provider Z.” However, it is not necessary for the request manager 120 to forward requests for “service B” and “service C” to “service provider X” because “service provider X” only performs “service A.” Thus, the request manager 120 may subdivide service requests received via second packaged request communications 144 before redirecting the requests to the appropriate request handlers 130.

Upon receipt of the second packaged request communications 144, the request handler 130 performs the requested service, employing the input parameters provided by the user via the requester interface 110. Examples of services include performing mathematical calculations; appraising real estate, fine art, or other personal property; and database lookup procedures such as may be employed to determine current stock prices, weather conditions, or other information. Of course, the scope of the present disclosure is not limited to such examples.

The first packaged result communications 145 may be substantially similar to the second packaged request communications 144, with the exception that the input parameters are replaced by the result of the service performed with the input parameters by or via the request handler 130. The service may be performed by the request handler 130 independent of any additional input, potentially not even including any input from the service provider that created and/or maintains the request handler 130. For example, the service may be performed by an automated program scripted in MICROSOFT EXCEL or other MICROSOFT OFFICE product, MATLAB, and others. However, the service may also be performed by a human and/or machine external to the service handler 130.

The second packaged result communications 146 may generally include data copied from one or more first packaged result communications 145. As with the request package subdivision performed by the request manager 120 described above, the request manager 120 may recombine service results received via the first packaged result communications 145 before redirecting the results to the appropriate requester interfaces 110.

Several or each of the above-described communications may be in the form of XML communication. However, other formats may also or alternatively be employed, including HTML and/or other languages. Various protocol may be employed for the communications, such as HTTP, SMTP, SIP, and/or SOAP, among others. The input parameters and result parameters, among other portions of the communications, may be or include text, graphics, video, and/or audio data.

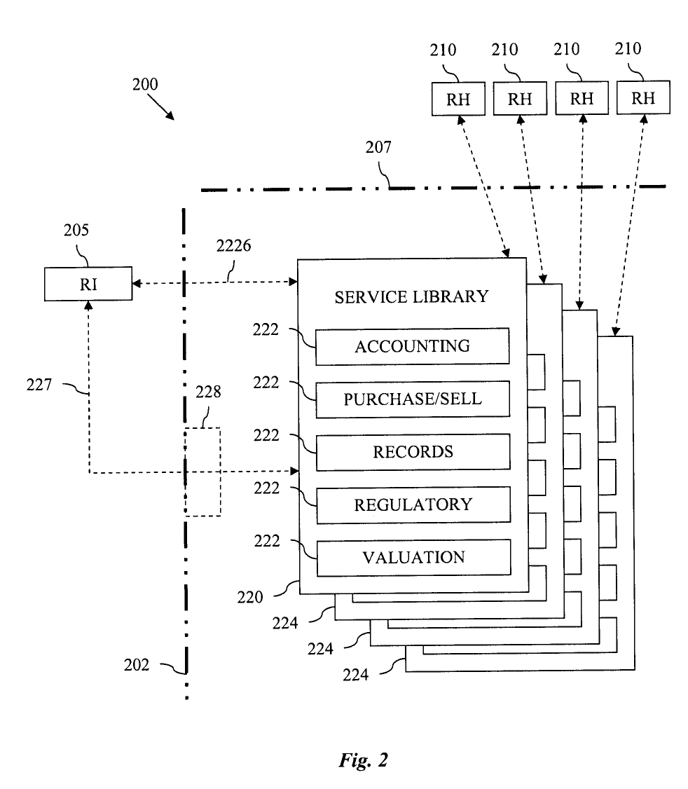

Referring to FIG. 2, illustrated is a schematic view of at least a portion of an embodiment of apparatus 200 according to one or more aspects of the present disclosure. The apparatus 200 may be or include at least a portion of the apparatus 100 shown in FIG. 1. A requester interface (RI) 205, which may be substantially similar to the requester interface 110 shown in FIG. 1, is included in the apparatus 200 or, alternatively, is located remote from the apparatus 200 but configured for communication with the apparatus 200 (e.g., over the Internet and/or another network). Thus, the apparatus 200 may include a firewall, network border, and/or other apparatus boundary 202 through which each RI 205 communicates with the apparatus 200. Similarly, a plurality of request handlers (RH) 210, which may be substantially similar to the request handlers 130 shown in FIG. 1, are each included in the apparatus 200 and/or located remote from the apparatus 200 but configured for communication with the apparatus 200. Consequently, the apparatus 200 may include a firewall, network border, and/or other apparatus boundary 207 through which each RH 210 communicates with the apparatus 200. The firewall, network border, and/or other apparatus boundaries 205 and 207 may also be the same component or module.

The apparatus 200 also includes one or more service libraries 220 structured as or in one or more web pages. The service libraries 220 represent an example implementation of the request manager 120 shown in FIG. 1. Each service library 220 includes a collection of menus or services from which a user can select. For example, in the embodiment depicted in FIG. 2, a service library 220 may present a user with several different classes of services which are currently available to at least that user. Examples may include ACCOUNTING, PURCHASE/SELL, RECORDS, REGULATORY, and VALUATION, such as designated by reference numeral 222 in FIG. 2. Additional service libraries 224 may be activated upon user selection of one of the service classes 222, which may in turn be utilized to activate further additional service libraries and/or service options.

Each of the service libraries 220, 224 may correspond to an associated one of the request handlers 210, as depicted in FIG. 2. However, more than one RH 210 may also be associated with the services and/or other options presented to the user in a single service library 220, 224. Moreover, the scope of the present disclosure is not limited to the service classes 222 illustrated in FIG. 2 and described above.

Communications between the apparatus 200 and the RI 205, when the RI 205 is located remote from the apparatus 200, may be through a direct interface, as indicated by dashed line 226 in FIG. 2. Alternatively, or additionally, such communications between the apparatus and the RI 205 may be through the firewall, network border, and/or other apparatus boundary 207 via one or more intermediary components 228 such as a message server, among other optional components. Such indirect communications are indicated by dashed line 227 in FIG. 2.

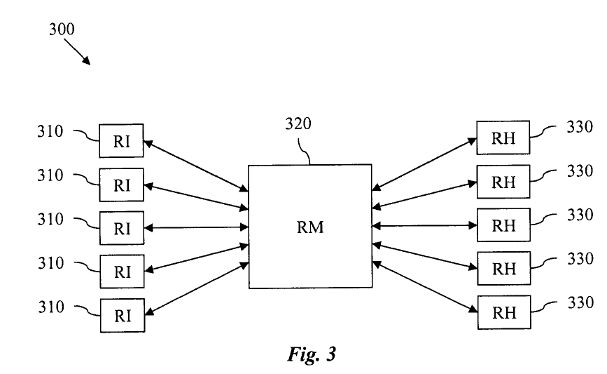

Referring to FIG. 3, illustrated is a block diagram of an embodiment of the apparatus 100 shown in FIG. 1 and/or the apparatus 200 shown in FIG. 2, herein designated by the reference numeral 300. The apparatus 300 includes several requester interfaces (RI) 310 that may each be substantially similar or identical to the RI 110 shown in FIG. 1 and/or the RI 205 shown in FIG. 2. The apparatus 300 also includes several request handlers (RH) 330, each of which may be substantially similar or identical to the RH 130 shown in FIG. 1 and/or the RH 210 shown in FIG. 2. The apparatus 300 also includes a request manager 320 that may be substantially similar or identical to the request manager 120 shown in FIG. 1 and/or at least a portion of the apparatus 200 shown in FIG. 2.

The request manager 320 is operable as an intermediary between each RI 310 and each RH 330. As in the description above, the request manager 320 may communicate with more than one RI 310 and more than one RH 330, such that service requests received by the request manager 320 from a particular RI 330 may be disseminated among the appropriate one or more RH 330, and such that service requests for the same service received from multiple RI 330 may be forwarded to a particular, corresponding RH 330. Thus, among other aspects, FIG. 3 reiterates the ability of a single request manager 320 to direct service requests and results among numerous different requester interfaces 310 and request handlers 330.

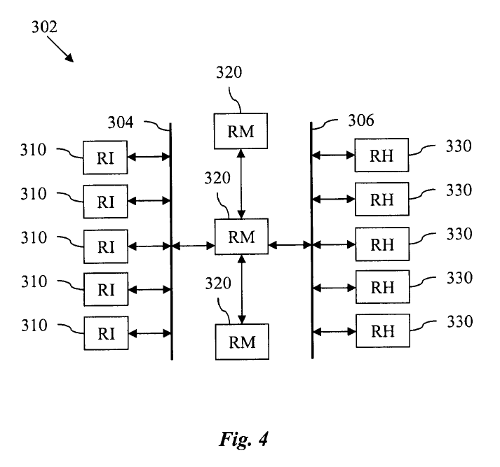

Referring to FIG. 4, illustrated is a block diagram of another embodiment of the apparatus 100 shown in FIG. 1 and/or the apparatus 200 shown in FIG. 2, herein designated by the reference numeral 302. The apparatus 302 includes the same or substantially similar RI 310 and RH 330 shown in FIG. 3. However, in contrast to the single request manager 320 shown in the embodiment of FIG. 3, the apparatus 302 of FIG. 4 includes multiple request managers 320 for directing service requests and results between the RI 310 and RH 330.

For example, the apparatus 302 may include a communications hub, bus, or other means 304 for handling the flow of communications between each of the RI 310 and the request manager 320. The apparatus 302 may also include a communications hub, bus, or other means 306 for handling the flow of communications between each of the RH 330 and the request manager 320. Each of the communications handling means 304, 306, when included, may be integral to the request manager 320 or, alternatively, may be a separate component of the apparatus 302. The communications handling means 304, 306 may each also include means for queuing communications to and from the request manager 320.

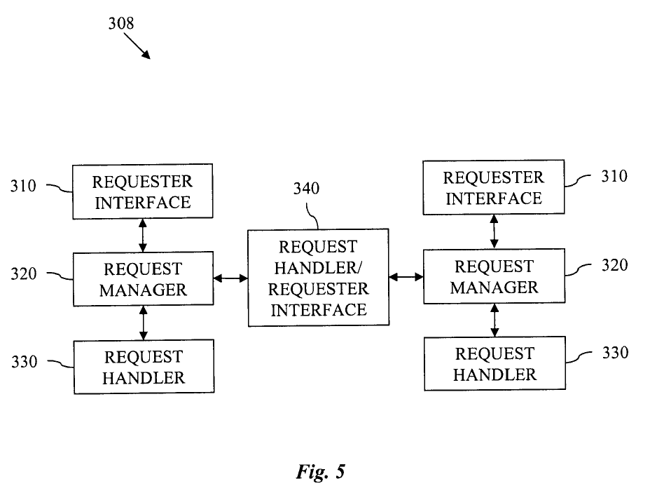

Referring to FIG. 5, illustrated is a block diagram of another embodiment of the apparatus 100 shown in FIG. 1 and/or the apparatus 200 shown in FIG. 2, herein designated by the reference numeral 308. The apparatus 308 includes the same or substantially similar RI 310 and RH 330 shown in FIG. 3. However, the apparatus 308 also includes a combination request handler/requester interface (RH/RI) 340.

The RH/RI 340 is configured to receive service requests from a request manager 320 in the same, above-described manner that the request handler 130, 210, or 330 is configured to receive service requests. However, as part of the service it performs, the RH/RI 340 generates a secondary service request to be communicated with another request handler 330 via one of the request managers 320.

For example, a user may utilize a requester interface 310 to submit a service request for receiving a quote for home-owner's insurance. A corresponding request manager 320 may subsequently forward the service request to the RH/RI 340. However, upon receiving the service request, the RH/RI 340 may desire verification of the value of the residence for which the insurance quote is requested. Consequently, the RH/RI 340 may generate a secondary service request to be sent to another request handler 330 (via a corresponding request manager 320) to receive the value of the residence for which the user requested the insurance quote. Upon receiving the verified value of the user's residence from the additional request handler 330, the RH/RI 340 may utilize such information to formulate the requested insurance quote, and then forward the service results back to the initiating requester interface 310 via the corresponding request manager 320.

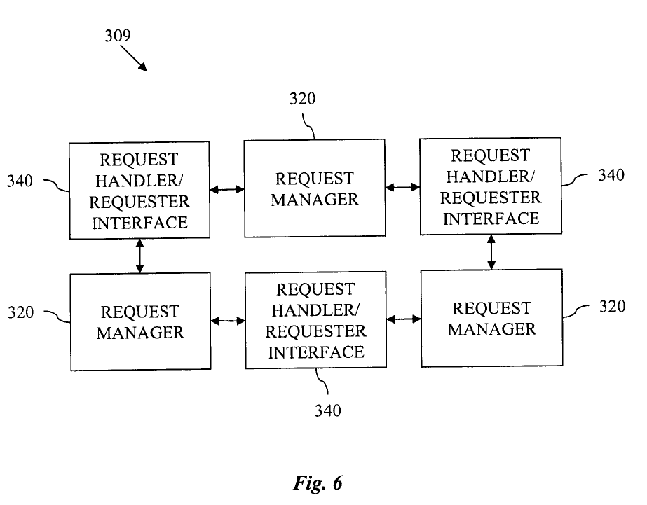

Referring to FIG. 6, illustrated is a block diagram of another embodiment of the apparatus 308 shown in FIG. 5, herein designated by the reference numeral 309. The apparatus 309 includes the same or substantially similar request managers 320 and RH/RI 340 shown in FIG. 5. However, the apparatus 309 includes multiple instances of the RH/RI 340, and does not include any dedicated requester interfaces or request handlers, in contrast to the previously discussed embodiments. Thus, among other aspects, FIG. 6 introduces the concept that apparatus within the scope of the present disclosure can include components for managing service requests and some number of components for initiating the service requests and handling (or performing) the service requests, although none of these components are necessarily dedicated to only initiating or handling service requests.

That is, as should be evident from the above discussion of FIGS. 1-6, an apparatus within the scope of the present disclosure may include: zero, one, or more requester interfaces; zero, one, or more request managers; zero, one, or more request handlers; and zero, one, or more combination request handler/requester interfaces. Moreover, any aspect described above with reference to an embodiment depicted in one of FIGS. 1-6 may be applicable or readily adaptable to other embodiments depicted in another one of FIGS. 1-6, as well as other embodiments within the scope of the present disclosure.

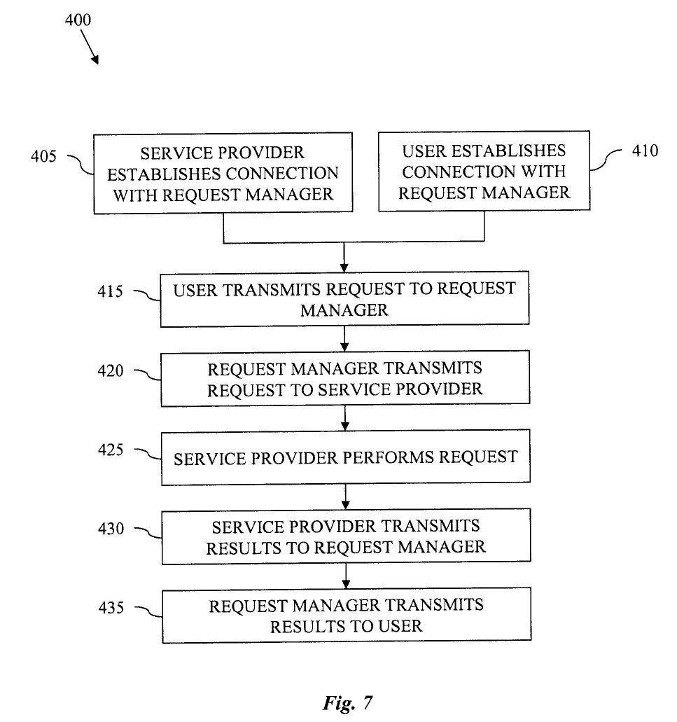

Referring to FIG. 7, illustrated is a flow-chart diagram of at least a portion of a method 400 according to one or more aspects of the present disclosure. The method 400 includes initial or intermediary steps during which a service provider (step 405) and a user (step 410) each establish connection with a request manager, possibly as described above where like terms are employed. For example, the service provider may register, authenticate, or otherwise associate with a request manager via a request handler, and a user may register, authenticate, or otherwise associate with the request manager via a requester interface.

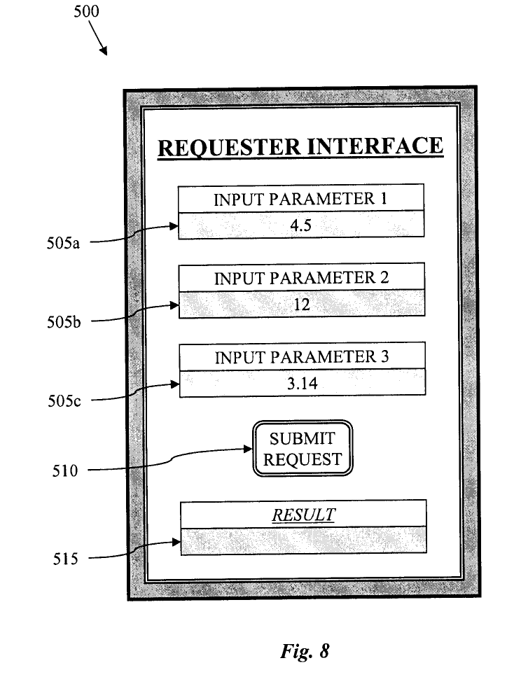

During a subsequent step 415, the user may transmit a service request to the request manager. For example, referring to FIG. 8, illustrated is an exemplary graphical user interface (GUI) 500 which may be utilized as a requester interface according to one or more aspects of the present disclosure. The requester interface 500 may include input fields 505a-c where the user may provide input parameters for the requested service. The input fields 505a-c may be text boxes in which the user may input alphanumeric values via, for example, keystrokes. Thus, for demonstrative purposes only and without limiting the scope of the present disclosure, the requester interface 500 shown in FIG. 5 is depicted as if the alphanumeric text “4.5” has been input by the user into input field 505a, the alphanumeric text “12” has been input by the user into input field 505b, and the alphanumeric text “3.14” has been input by the user into input field 505c. However, the input fields 505a-c may also be or include drop-down boxes, menu selectors, radio buttons, knobs, slides, and/or other means for inputting parameters to be utilized by a request handler in performing the requested service. Moreover, the input parameters may be text, images, videos, and/or other data types. The requester interface 500 may also include request submission means, such as the “clickable” button 510 labeled “SUBMIT REQUEST” in FIG. 8, as well as an area 515 in which the service result may be displayed.

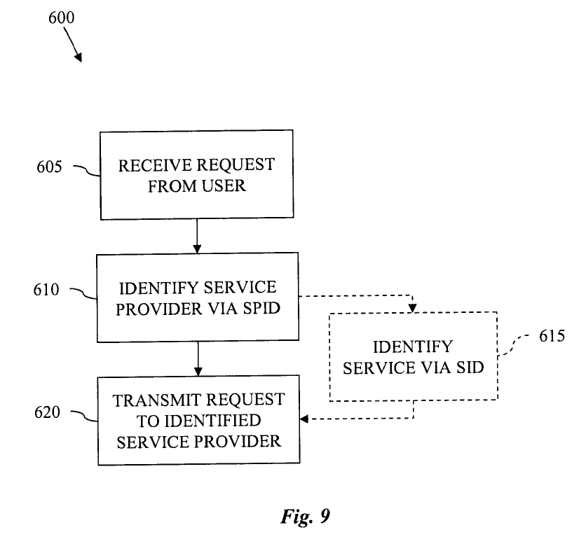

Returning to FIG. 7, once the request manager receives the service request from the user via the requester interface, the request manager transmits the service request to the appropriate service handler in a subsequent step 420. For example, turning to FIG. 9, illustrated is a flow-chart diagram depicting at least a portion of a method 600 which may be performed during step 420 of the method 400 shown in FIG. 7. The method 600 includes a step 605 in which the service request is received by the request manager from the user via the requester interface. In a subsequent step 610, the service provider may be identified by the SPID included in the service request communication. In an optional step 615, the requested service may also be identified by the SID that may also be included in the service request communication. Thereafter, in a step 620, the request manager forwards the service request to the appropriate service provider using the results of step 610 and, possibly, step 615.

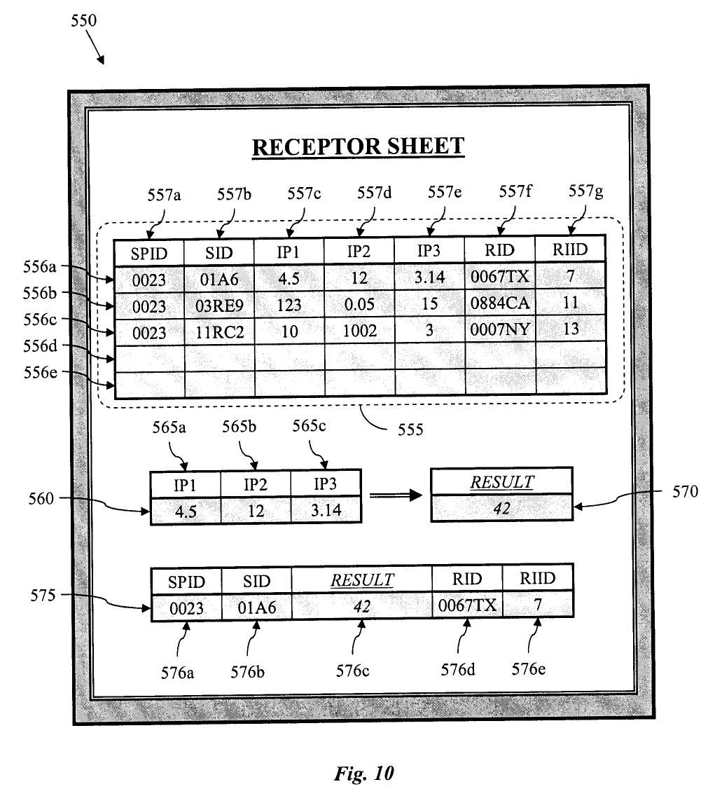

Returning once again to FIG. 7, once the request handler receives the service request from the request manager, the request handler performs the requested service in a step 425. For example, turning to FIG. 10, illustrated is an exemplary “receptor sheet” or other spreadsheet interface 550 which may be utilized as a request handler according to one or more aspects of the present disclosure. The receptor sheet 550 includes a queue 555 having rows 556a-e and columns 557a-g. Each row 556a-e represents a single service request received from the request manager. Column 557a includes the service provider identification (SPID), although such column is optional as this data may not be required to perform the requested service. Column 557b includes the service identification (SID), such as where a particular service provider or handler performs more than one service. Column 557f includes the user or requester identification (RID), and column 557g includes the user or request instance identification (RIID), although such columns are optional as these data may not be required to perform the requested service.

Columns 557c-e include input parameters IP1-3, respectively, provided by the user via the requester interface. For example, referring to FIGS. 8 and 10 collectively, the input parameters “4.5,” “12,” and “3.14” input by the user via input fields 505a-c may be manually or automatically input into columns 557c-e in the receptor sheet 550.

The queue 555 may be a first-in-first-out (FIFO) queue in which the oldest entry is utilized during each iteration of performing the service implemented by the receptor sheet 550. However, other types of queues may also or alternatively be employed. Service requests received by the receptor sheet 550 may be executed asynchronously.

During a single iteration of the service performed by the receptor sheet 550, data from one of the rows 556a-e may be copied to a “service” or other portion 560 so that the data can be utilized to perform the requested service. For example, in the example depicted in FIG. 10, the input parameters from row 556a, column 557c-e are copied to columns 565a-c, respectively, of service portion 560. Such copy may be performed by a macro, by linking spreadsheet cells of the queue 555 to corresponding cells of the service portion 560, and/or by other means.

The receptor sheet 550 may subsequently employ the data in the service portion 560 to perform the requested service. For example, in the implementation depicted in FIG. 10, the result of the particular service that is performed by the receptor sheet 550 is the alphanumeric result “42” when utilizing the input parameters “4.5,” “12,” and “3.14.” The receptor sheet 550 may include a “result” portion 570 in which the result of the service is contained and possibly displayed after each iteration of performing the service.

Thereafter, the result may be employed to generate a service result package, as described above. For example, the receptor sheet 550 may include a “result package” portion 575 which includes a cell 576a for indicating the SPID (“0023” in FIG. 10), a cell 576b for indicating the SID (“01A6”), a cell 576c for indicating the service result (“42”), a cell 576d for indicating the RID (“0067TX”), and/or a cell 576e for indicating the RIID (“7”).

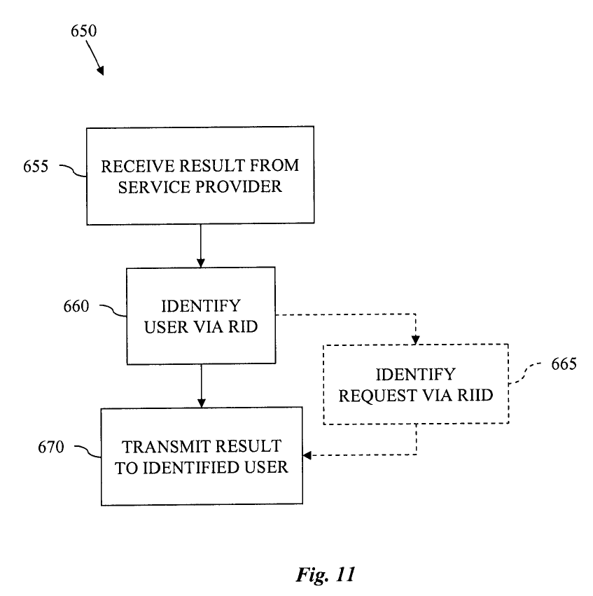

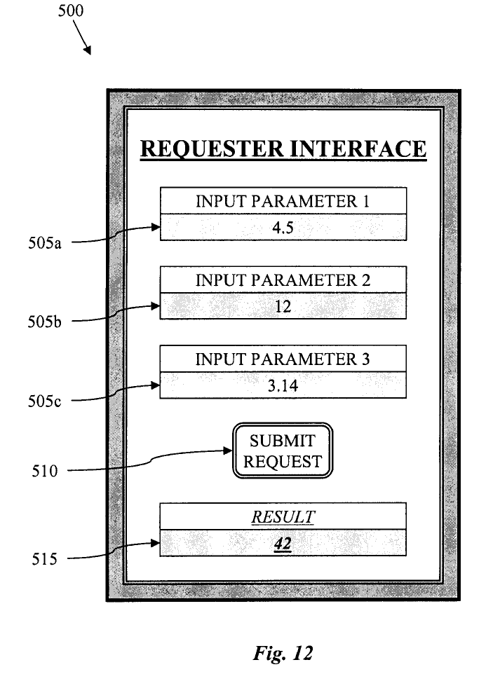

Returning to FIG. 7, The result package may then be forwarded to the request manager in a subsequent step 430, and then to the requesting user in step 435. For example, turning to FIG. 11, illustrated is a flow-chart diagram depicting at least a portion of a method 650 which may be performed during step 430 of the method 400 shown in FIG. 7. The method 650 includes a step 655 in which the result package is received by the request manager from the request handler. In a subsequent step 660, the user may be identified by the RID originally included in the service request communication and now included in the result package communication. In an optional step 665, the request instance may also be identified by the RIID that may also be included in the service request and/or result package communications. Thereafter, in a step 670, the request manager forwards the service result to the requesting user via the requester interface using the results of step 660 and, possibly, step 665. Consequently, the requester interface 500 may be updated with service result received via the result package. For example, as shown in FIG. 12, the service result (“42”) may be displayed in the above-described service result area 515.

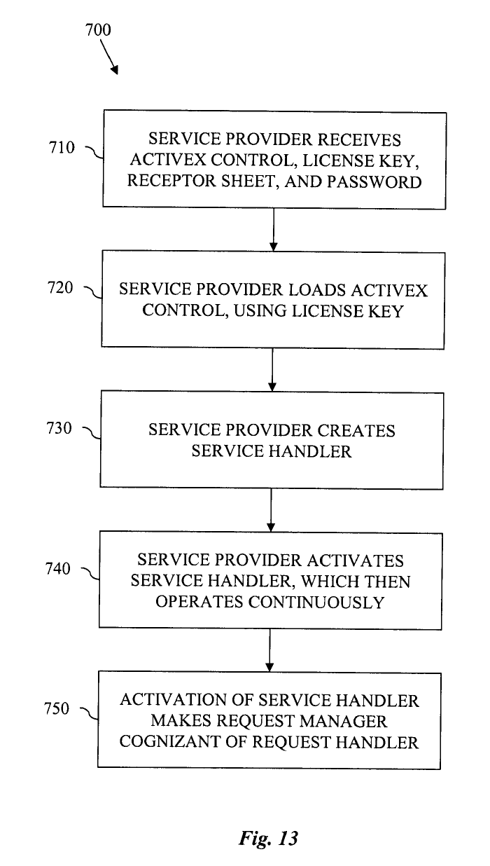

Referring to FIG. 13, illustrated is a flow-chart diagram of at least a portion of a method 700 according to one or more aspects of the present disclosure. The method 700 may be utilized in the activation of a service handler with a service manager, as may be performed by a service provider.

The method includes a step 710 during which the service provider receives ActiveX control, a license key, a receptor sheet, and possibly a password. In a subsequent step 720, the service provider loads the ActiveX control, possibly using the license key that may have been received by the service provider in step 71 0. This process of loading the ActiveX control, whether with or without the license key, may be referred to as “registration” or “setup” of the service provider, or may be a part of such registration. At least with regard to some aspects of the present disclosure, registration may be distinguished from authentication in that registration may be static, or performed only once for each service provider, whereas authentication may be performed more than once, and may thus be “dynamic.”

A subsequent step 730 includes the service provider creating the request handler, such as one or more MICROSOFT EXCEL files. This process may include creating, or adding, a receptor sheet into the MICROSOFT EXCEL file or other request handler, such as the receptor sheet 550 described above.

In a following step 740, the service providers activates the request handler. For example, such activation may merely include saving, closing, and reopening the MICROSOFT EXCEL file or other request handler after the receptor sheet has been incorporated therein. However, other means for activating the request handler may also be employed. For example, the service provider may “click” an “activate” button in the request handler file or elsewhere, which may complete the activation process.

After activation, the request handler may remain running (e.g., answering service requests) continuously. However, such operation may also be configured such that the request handler terminates, inactivates, or otherwise ceases answering service requests upon the termination of ActiveX or MICROSOFT EXCEL, or upon a VISUAL BASIC macro running in EXCEL that may trigger termination, such as a macro that includes a “run only between 8 AM and 5 PM” rule or a “stop running at 5 PM until started again” rule or a “stop running at 5 PM until 8 AM” rule. However, the scope of the present disclosure is not limited to such embodiments. The method 700 may also include step 750, in which the request manager, which has likely been in continuous operation during the previous steps 710-740 of method 700, becomes aware of the newly-activated request handler and its location in response to the activation of the request handler.

The service handler of the implementations described above (e.g., MICROSOFT EXCEL), as well as others within the scope of the present disclosure, may be configured to continuously operate after activation with the request manager or otherwise within the system. For example, the service handler may continue operating until the service provider powers-off or otherwise inactivates the service handler. In other words, the service handler is not activated by the user or requester interface, and can even be anonymous relative to the user or requester interface. Consequently, the user or requester interface may need to only know the name of the service being requested, when selecting the service name from the requester interface or the service library of the request manager. Thus, the user or requester interface need not know the location or address of the service handler or provider.

Similarly, the user or requester interface also does not need to be cognizant of the structure of the provided service. That is, the requester interface and/or request manager is operable for the user to select the desired service and input the appropriate input parameters needed to perform the service, and the structure of this information is maintained by the requester interface and/or the request manager, such that the user need not know the data structure needed to perform the service. Subsequently, the service handler is operable to perform any restructuring of the input parameters necessary to perform the requested service, thus alleviating the need for the user to do so.

It is also noteworthy that the apparatus and/or system implementations within the scope of the present disclosure may lend themselves to numerous potential billing mechanisms. For example, any one or more of the requester interface, the request manager and the request handler may be used in the billing process, whether to record a billable event, to verify a recorded billable event, to accept or discount a recorded billable event, and/or for other billing purposes.

Utilization of a uniform resource locator (URL) may also be incorporated into one or more steps or methods performed within the apparatus and/or system implementations within the scope of the present disclosure. For example, a user or service requester may submit a request package communication to the request manager by requesting a URL that establishes a temporary connection with the request manager (e.g., via a URL prefix “sss://” or some other prefix) and subsequently sends one or more of the SID, SIID, RID, RIID, and/or other parameters along with the input parameters to the request manager. In such an implementation, the identification data and/or the input parameters may be embedded, concatenated, or otherwise encoded within the URL. Once the service has been performed by the service handler and the service results are transmitted to the request manager, the request manager may send the service results to the requester interface as, for example, an XML communication.

In embodiments described above or otherwise within the scope of the present disclosure, the request handler may include load-sharing or load-allocation means, such as when multiple instances of a service provider's request handler is activated. More than one request manager may also connect to a single instance of a request handler, or a first request manager may connect to a request handler through a second request manager. In addition, communication with a request handler by a request manager may originate from a wireless source. For example, a requester interface may be (or be implemented in) a wireless device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method for communication of service requests and service results between remotely located users and service providers, comprising:
establishing connectivity between service providers and a request handler;
establishing connectivity between remotely located users and the request handler;
receiving service requests at the request handler;
identifying from each service request a service provider ID and transmitting the service request to a unique service provider associated with the service provider ID;
entering service requests received by the unique service provider in a queue located central to the unique service provider, the queue existing in a spreadsheet computer program being executed by the unique service provider;
removing an individual entry in the queue for performing the requested service via the spreadsheet computer program to generate a result; and
generating a result package comprising the result.

2. A method of communicating a plurality of service requests and corresponding responses between a plurality of users and service providers, comprising:
establishing a connection with a user;
receiving a packaged service request from the user;
transmitting the packaged service request to a service provider;
receiving a packaged service result from the service provider; and
transmitting the packaged service result to the user.

3. A method of repeatedly performing a service in response to receiving a plurality of service requests, comprising:
receiving a plurality of packaged service requests from a remote location;
queuing data obtained from each of the plurality of packaged service requests;
utilizing each queued data entry associated with a unique one of the plurality of packaged service requests to perform the service, thereby generating a plurality of packaged service results each corresponding to one of the plurality of packaged service requests; and
transmitting the plurality of packaged service results to the remote location.

4. A method of operating a Web Service, comprising:
receiving into a spreadsheet program a service request transmitted from a network interface;
adding the service request to a service request queue integral to the spreadsheet program;
removing the service request from the service request queue;
performing a service by utilizing data from the service request, thereby generating a service result; and
transmitting the service result from the spreadsheet program to the network interface.
